(19) United States
(12) Patent Application Publication
(10) Pub. No.: US 2009/0310455 A1
(43) Pub. Date: Dec. 17, 2009

(54) Optical Disc Reproducing Apparatus, In-Vehicle Optical Disc Reproducing Apparatus, In-Vehicle Optical Disc Reproducing System, and Optical Disc Reproducing Method

(75) Inventor: Osamu Uchiyama, Hiratsuka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 12/430,367

(22) Filed: Apr. 27, 2009

(30) Foreign Application Priority Data
Jun. 16, 2008 (JP) 2008-156822

(51) Int. Cl. G11B 19/04

(52) U.S. Cl. 369/53.21; G9B/7; G9B/19.005

(57) ABSTRACT

An in-vehicle optical disc reproducing apparatus according to the present invention reads disc specific information from an optical disc, and inputs vehicle specific information from an IC card, or the like. Next, the in-vehicle optical disc reproducing apparatus creates an encryption key from the disc specific information and the vehicle specific information, and then uses the created encryption key to encrypt content stored on the optical disc before the encrypted content is stored in a HDD. During the above process, if shaking of a vehicle is detected, the processing of storing the encrypted content to the HDD is stopped. When the encrypted content is reproduced, the disc specific information is checked. Only when an original disc is inserted, the encrypted content is decrypted by use of the stored encryption key to generate the original content so that the original content can be reproduced.

As a result, the in-vehicle optical disc reproducing apparatus can permit only an authorized user to stably reproduce the content with the copyright of the content protected.

### CLAIMS OF PRIORITY

The present application claims priority from Japanese patent application serial no. JP2008-156822, filed on Jun. 16, 2008, the content of which is hereby incorporated by reference into this application.

### BACKGROUND OF THE INVENTION

The present invention relates to an optical disc reproducing apparatus that employs a technique for permitting only an authorized user to reproduce content recorded on an optical disc with a copyright of the content protected. The invention more particularly relates to an optical disc reproducing apparatus that is suitable for the reproduction performed when the optical disc reproducing apparatus is placed in a vehicle.

Recently, because content including a picture image and sound is digitized, the content is more frequently stored on an optical disc (a CD, a DVD, or the like) when the content is provided.

Digital data is easy to copy, and copying of the digital data causes no degradation. Therefore, standards of DVD and Blu-ray Disc propose copy protection techniques including CSS (Content Scrambling System) so that a copyright of content is protected.

If the CSS is employed, digital data written to a DVD is encrypted to prevent the digital data from being copied; and a key for decrypting the encrypted data is stored in a DVD player or is embedded in DVD reproduction software. Only when the data is reproduced in an authorized process, the encryption is disabled. The content which is subjected to copy protection based on the CSS requires decryption. Therefore, the content cannot be reproduced even if a file existing on the DVD is to be copied to a HDD (hard disk drive).

Incidentally, Blu-ray Disc media, which succeed to DVD based storage media, have the increased recording density. Accordingly, the Blu-ray Disc media are expected to come into widespread use. The Blu-ray Disc media use a blue-violet semiconductor laser to read data. The track width of each Blu-ray Disc medium is also remarkably narrower than that of a DVD medium.

In one mode, a user may be provided with content from a content delivery server. For example, according to JP-A-2003-242038, copy information including a copy source PCID, a copy source player ID, and a content ID is registered. Next, user information is registered in a server both at a copy source and at a copy destination. When a copied file is reproduced, the reproduction of the file is permitted only when the user information is successfully verified at the copy destination. This makes it possible to achieve both protection of a copyright of the content and copying of the content.

As described above, because the track width of the Blu-ray Disc media is narrowed, there is a possibility that content will not be stably reproduced in an environment in which shaking and vibrations occur (for example, when a Blu-ray Disc medium containing the content is used with the medium placed in a vehicle). Therefore, it is desirable that the content be copied to a HDD before the content is reproduced. However, if copy-protected data based on the above-described CSS is simply copied to the HDD, the copied data cannot be reproduced. In the case of the DVD media, the Blu-ray Disc media, and the like, data which is not copy protected cannot be provided from the first with the exception of free content from the viewpoint of the copyright protection.

Therefore, it is necessary to provide such a mechanism that in an environment in which shaking and vibrations occur (for example, in an in-vehicle environment), content is copied to a mass storage device such as a HDD, and the copied content is then reproduced with a copyright of the content protected.

Moreover, as disclosed in, for example, JP-A-2003-242038, if user information is stolen in an environment in which a connection between a content delivery server and a user's reproducing apparatus is made through a network, copying is carried out without limitation, resulting in illegal reproduction.

The present invention has been devised to solve the above-described problems. An object of the present invention is to provide an optical disc reproducing apparatus in which, when an optical disc (for example, a DVD, a Blu-ray Disc, or the like) containing content whose copyright is protected is reproduced, only an authorized user is permitted to reproduce the content with the copyright of the content protected.

In particular, the present invention is devised to provide an optical disc reproducing apparatus that is capable of stably reproducing content stored on a Blu-ray Disc even if the optical disc reproducing apparatus is placed at a location where shaking and vibrations occur (for example, in a vehicle).

### SUMMARY OF THE INVENTION

An in-vehicle optical disc reproducing apparatus placed in a mobile object such as a vehicle according to the present invention reads disc specific information from an inserted optical disc, and inputs vehicle specific information, which is information specific to a vehicle, from an IC card, or the like.

Next, the in-vehicle optical disc reproducing apparatus creates an encryption key from the disc specific information and the vehicle specific information, and then uses the created encryption key to encrypt content stored on the optical disc before the encrypted content is stored in a HDD.

While the encrypted content is stored in the HDD, if shaking of the vehicle is detected, processing of storing the encrypted content to the HDD is stopped.

When the encrypted content stored in the HDD is reproduced, the encrypted content is decrypted by use of the stored encryption key to generate and reproduce the original content.

In this case, the reproduction of the original content is permitted only when an original disc containing the original content is inserted. A judgment as to whether or not the original disc is inserted can be made by checking whether or not disc specific information of a currently inserted optical disc coincides with the optical disc specific information used when the encryption key has been created.

### BRIEF DESCRIPTION OF DRAWINGS

FIG. 1 is a diagram illustrating a configuration of an in-vehicle optical disc reproducing apparatus 101 according to a first embodiment of the present invention;

FIG. 2 is a diagram illustrating a hardware configuration of the in-vehicle optical disc reproducing apparatus 101 according to the first embodiment of the present invention;

FIG. 3 is a flowchart illustrating processing of copying content by the in-vehicle optical disc reproducing apparatus 101 according to the first embodiment of the present invention;

FIG. 4 is a flowchart illustrating processing of reproducing content by the in-vehicle optical disc reproducing apparatus 101 according to the first embodiment of the present invention;

FIG. 5 is a diagram illustrating a configuration of an in-vehicle optical disc reproducing system according to a second embodiment of the present invention;

FIG. 6 is a diagram illustrating a hardware configuration of a content copying apparatus according to the second embodiment of the present invention;

FIG. 7 is a diagram illustrating a hardware configuration of an in-vehicle optical disc apparatus according to the second embodiment of the present invention;

FIG. 8 is a flowchart illustrating processing of copying content by the content copying apparatus 201 according to the second embodiment of the present invention;

FIG. 9 is a flowchart illustrating processing of reproducing content by the in-vehicle optical disc reproducing apparatus 219 according to the second embodiment of the present invention;

FIG. 10 is a diagram illustrating a configuration of an in-vehicle optical disc reproducing system according to a third embodiment of the present invention;

FIG. 11 is a diagram illustrating a hardware configuration of an in-vehicle optical disc reproducing apparatus according to the third embodiment of the present invention;

FIG. 12 is a diagram illustrating a hardware configuration of a content delivery server according to the third embodiment of the present invention;

FIG. 13 is a diagram illustrating a configuration of an in-vehicle optical disc reproducing system according to a fourth embodiment of the present invention;

FIG. 14 is a diagram illustrating a hardware configuration of a content copying apparatus according to the fourth embodiment of the present invention; and

FIG. 15 is a diagram illustrating a hardware configuration of a content delivery server according to the fourth embodiment of the present invention.

### DESCRIPTION OF THE PREFERRED EMBODIMENT

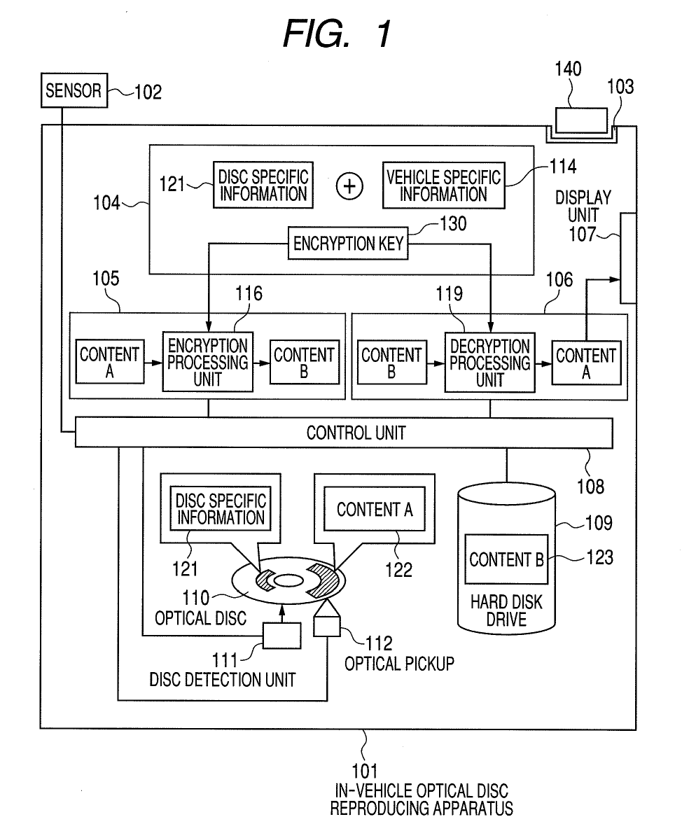

Embodiments of the present invention will be described with reference to FIG. 1 to FIG. 15 as below.

### First Embodiment

A first embodiment of the present invention will be described below with reference to FIG. 1 to FIG. 4.

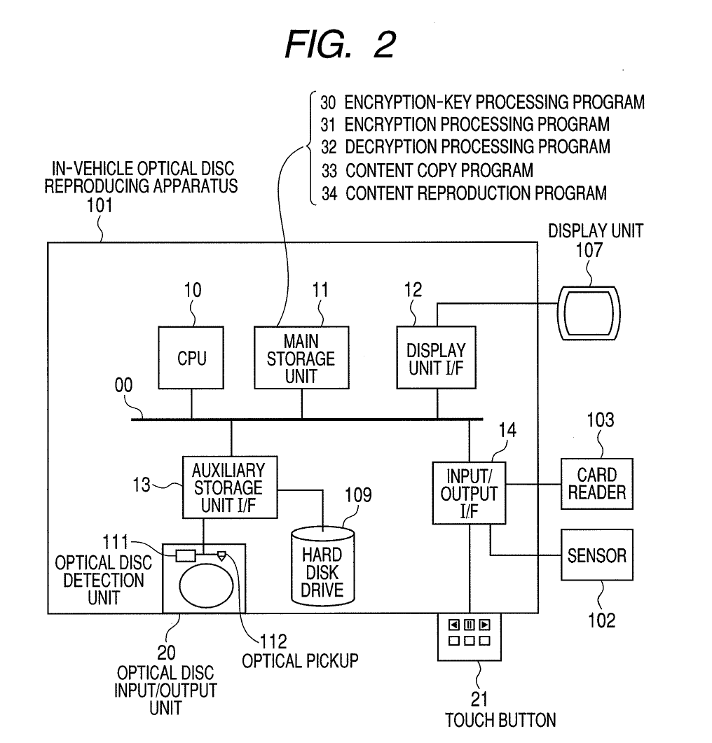

First of all, a system configuration of an optical disc reproducing apparatus according to a first embodiment of the present invention will be described with reference to FIGS. 1 and 2.

FIG. 1 is a diagram illustrating a configuration of an in-vehicle optical disc reproducing apparatus 101 according to the first embodiment of the present invention.

FIG. 2 is a diagram illustrating a hardware configuration of the in-vehicle optical disc reproducing apparatus 101 according to the first embodiment of the present invention.

FIG. 1 schematically illustrates the configuration of the in-vehicle optical disc reproducing apparatus 101 according to this embodiment with the main focus placed on the relationship between each function and data to be handled.

The in-vehicle optical disc reproducing apparatus 101 according to this embodiment is so devised that a control unit 108 can read data stored on an optical disc 110 and data stored in a hard disk drive 109.

The control unit 108 of the in-vehicle optical disc reproducing apparatus 101 performs arithmetic processing of data in each of memory areas 104, 105, and 106 as shown in the figure.

In addition, information is inputted from a sensor 102 into the control unit 108 of this in-vehicle optical disc reproducing apparatus 101 so that shaking, vibrations, and the like, which have occurred in the in-vehicle optical disc reproducing apparatus 101 or a vehicle equipped therewith, can be detected. The sensor 102 is, for example, a vehicle speed meter, an engine revolution sensor, a gyrocompass, or an acceleration sensor.

Moreover, the in-vehicle optical disc reproducing apparatus 101 includes an input-output device such as a card reader 103 for reading information from an IC card 140 or a magnetic card. Accordingly, information can be inputted from the IC card 140 or the magnetic card into the in-vehicle optical disc reproducing apparatus 101.

The optical disc 110 includes disc specific information, and stores content A. The disc specific information is, for example, information such as BCA (Burst Cutting Area) which is a serial ID that is uniquely assigned as a bar code on a disc basis.

The content A is, for example, video data which a user desires to view.

Although not illustrated, the in-vehicle optical disc reproducing apparatus 101 includes a mechanism for reading data from the optical disc 110. A display unit 107 displays a picture image relating to the content A, and outputs sound.

FIG. 2 illustrates in more detail the hardware configuration of the in-vehicle optical disc reproducing apparatus 101.

The in-vehicle optical disc reproducing apparatus 101 is configured such that a CPU 10,a main storage unit 11, a display unit I/F 12, an auxiliary storage unit I/F 13, and an input/output I/F 14 are connected to one another through a bus 00.

The CPU 10 controls each of the above-described elements, and executes a program stored in the main storage unit 11.

The main storage unit 11 stores temporary data, and stores a program that has been loaded from the hard disk drive 109.

Programs to be executed in this embodiment include an encryption-key processing program 30, an encryption processing program 31, a decryption processing program 32, a content copy program 33, and a content reproduction program 34.

The encryption-key processing program 30 is a program for creating an encryption key 130 from vehicle specific information 114 included in the IC card 140 or the magnetic card, and from disc specific information 121 of the optical disc, and then for keeping the encryption key 130 stored.

The encryption processing program 31 is a program for encrypting content A by use of the encryption key 130 to generate encrypted content B.

The decryption processing program 32 is a program for decrypting the content B, which has been generated by the encryption based on the encryption key 130, so as to generate the content A that is an original plain text.

The content copy program 33 is a program for copying the content A to the hard disk drive 109 in the form of the encrypted content B in response to a situation judged by information inputted from the sensor 102.

The content reproduction program 34 is a program for detecting whether or not an original optical disc 110 is inserted into the optical disc input/output unit 20, and for, if it is judged that the original optical disc 110 is inserted into the optical disc input/output unit 20, reproducing the content B that has been copied to the hard disk drive 109.

The display unit I/F 12 is an interface through which the display unit 107 is connected to the in-vehicle optical disc reproducing apparatus 101.

The auxiliary storage unit I/F 13 is an interface (for example, EIDE) that connects between the optical disc input/output unit 20 and the hard disk drive 109.

The optical disc input/output unit 20 is an element for performing processing of reading data of the optical disc 110, detecting whether or not the optical disc 110 is inserted, and the like. The optical disc input/output unit 20 includes a disc detection unit 111 and an optical pickup 112, both of which are shown in FIG. 1.

The hard disk drive 109 is a large-capacity magnetic storage device. As shown in FIG. 1, the hard disk drive 109 stores the encrypted content B. The hard disk drive 109 also stores a program to be executed in the in-vehicle optical disc reproducing apparatus 101, and other temporary data, although they are not illustrated.

The input/output I/F 14 is an interface (for example, USB) through which input-output devices including the card reader 103, the sensor 102, and a touch button 21 are connected to the in-vehicle optical disc reproducing apparatus 101.

The touch button 21 is an input device that is used by a user to operate the in-vehicle optical disc reproducing apparatus 101.

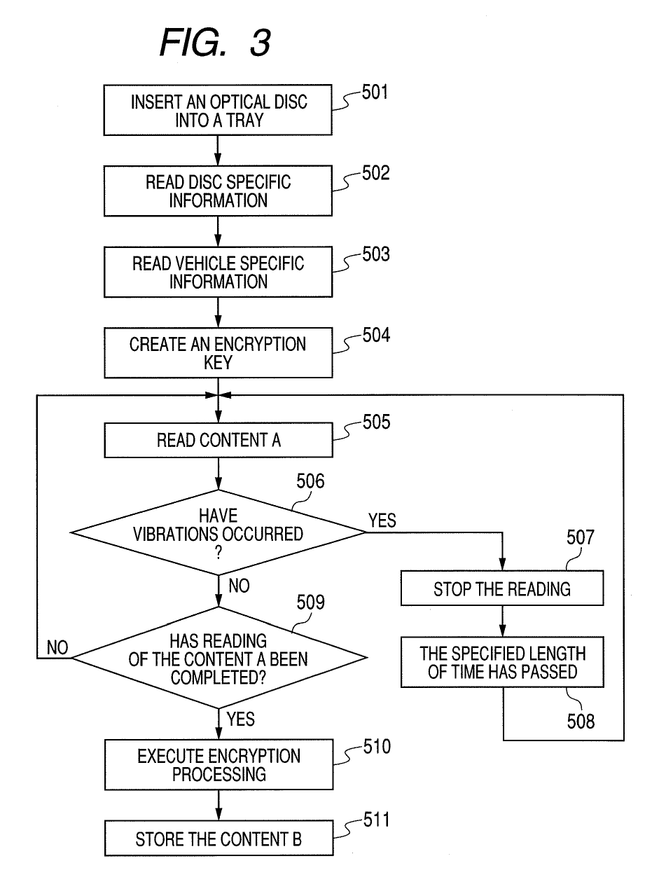

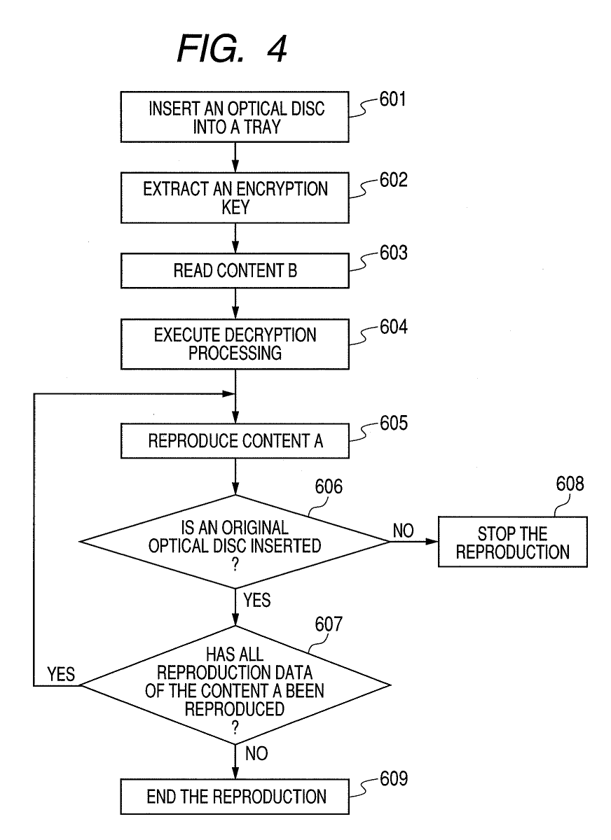

Next, processing of the in-vehicle optical disc reproducing apparatus 101 according to this embodiment will be described with reference to FIGS. 3 and 4 as well as FIGS. 1 and 2 described above.

FIG. 3 is a flowchart illustrating processing of copying content by the in-vehicle optical disc reproducing apparatus 101 according to the first embodiment of the present invention.

FIG. 4 is a flowchart illustrating processing of reproducing content by the in-vehicle optical disc reproducing apparatus 101 according to the first embodiment of the present invention.

First of all, processing in which the content B generated by encrypting the content A of the optical disc 110 is stored in the hard disk drive 109 will be described with reference to FIG. 3.

First of all, a user who desires to reproduce content of the optical disc 110 inserts the optical disc 110 into a tray of the optical disc input/output unit 20 (step 501).

Next, the control unit 108 reads the disc specific information 121 of the optical disc 110 (step 502), and keeps the disc specific information 121 stored in the memory area 104 of the main storage unit 11.

Next, through the card reader 103, the control unit 502 reads the vehicle specific information 114 written to the IC card or the magnetic card (step 503), and keeps the vehicle specific information 114 stored in the memory area 104 of the main storage unit 11.

The vehicle specific information 114 is information read by, for example, the IC card 140 of the ETC (Electronic Toll Collection System) system.

The control unit 502 then creates the encryption key 130 from the disc specific information 121 and the vehicle specific information 114 that have been read (step 504), and keeps the encryption key 130 stored in the memory area 104 of the main storage unit 11. When the encryption key 130 is created, for example, a bit string of the disc specific information 121 and a bit string of the vehicle specific information 114 are combined together, and the combined bit string is then inputted into a program that uses existing cryptography algorithm.

Next, the control unit 502 reads the content A into the memory area 104 of the main storage unit 11 (step 505).

In this case, the control unit 502 monitors information inputted from the sensor 102 to judge whether or not vibrations have occurred. If it is judged that vibrations have occurred, the reading is temporarily stopped (steps 507, 508).

In addition, a judgment as to whether or not the reading of the content A into the memory area 104 is allowed may also be made based on whether or not a vehicle is driven at specified vehicle speed or less judging from the vehicle speed meter, or whether or not an engine operates at specified revolution speed or less.

On the completion of the reading of the content A (step 509), the encrypted content B is generated on the basis of the encryption key 130 created for the content A (step 510).

The encrypted content B is then stored in the hard disk drive 109 (step 511).

Next, processing in which the content A is generated by decrypting the content B stored in the hard disk drive 109, and in which the content A is then reproduced, will be described with reference to FIG. 4.

When the content A is reproduced, an optical disc is inserted into the tray of the optical disc input/output unit 20 (step 601). Incidentally, this operation is not required if the optical disc is kept inserted into the tray just as it is (for example, immediately after the content A has been copied as the content B).

Next, the control unit 108 extracts the stored encryption key 130 (step 602).

After that, the content B is read from the hard disk drive 109 into the memory area 106 (step 603). The content B is then subjected to decryption processing based on the extracted encryption key 130 (step S604) so as to generate the content A that is a plain text.

Then, the reproduction of the generated content A is started (step 605).

When the content A is reproduced, the control unit 108 checks whether or not an original optical disc is inserted into the optical disc input/output unit 20 (step S606). If it is judged that the original optical disc is not inserted into the optical disc input/output unit 20, the control unit 108 stops the reproduction of the content A (step 608). Whether or not the original optical disc is inserted into the optical disc input/output unit 20 is checked by comparing the disc specific information, which has been read at the time of copying to create the encryption key, with specific information of the optical disc 110 that is currently inserted. To be more specific, if the disc specific information, which has been read at the time of copying to create the encryption key, does not coincide with the specific information of the optical disc 110 that is currently inserted, or if no optical disc is inserted into the optical disc input/output unit 20, it is judged that the original optical disc is not inserted thereinto. As a result, the reading is stopped. Thus, if the original optical disc is not inserted into the optical disc input/output unit 20, even if the content A is copied, the content A cannot be reproduced.

The reproduction of the content A is continued until all reproduction data of the content A is reproduced (steps 607, 609).

Incidentally, because this embodiment describes a case where the in-vehicle optical disc apparatus is used, information which is paired with the disc specific information 121 to create the encryption key 130 is the vehicle specific information 114. However, the information to be paired with the disc specific information 121 is not limited to the vehicle specific information 114 depending on the use of the optical disc apparatus. Environmental information about a position at which the optical disc apparatus is located, or specific information of the optical disc apparatus itself (for example, a device ID), may also be paired with the disc specific information 121 so long as it can uniquely identify the optical disc apparatus.

### Second Embodiment

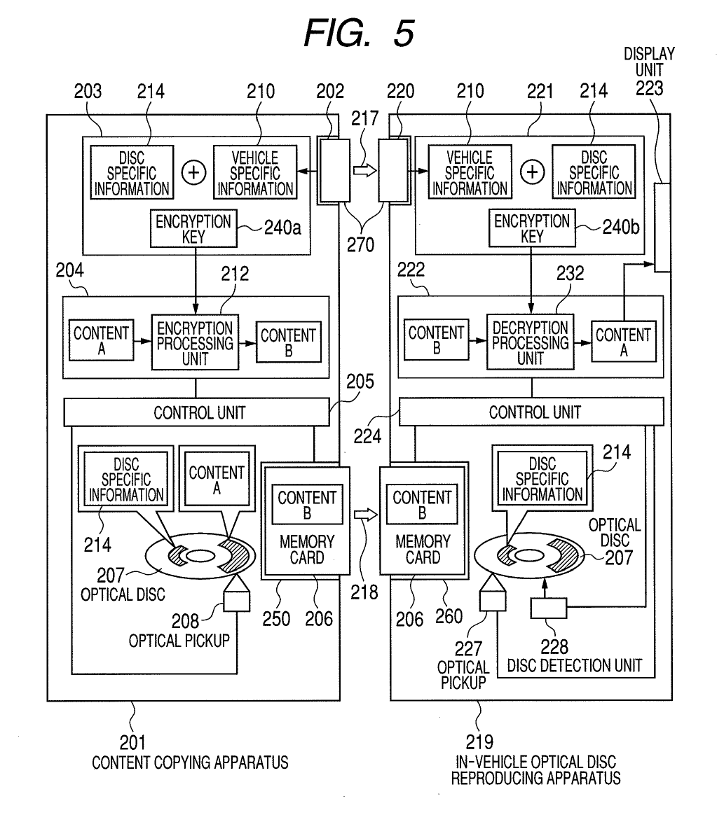

A second embodiment of the present invention will be described below with reference to FIG. 5 to FIG. 7.

FIG. 5 is a diagram illustrating a configuration of an in-vehicle optical disc reproducing system according to the second embodiment of the present invention.

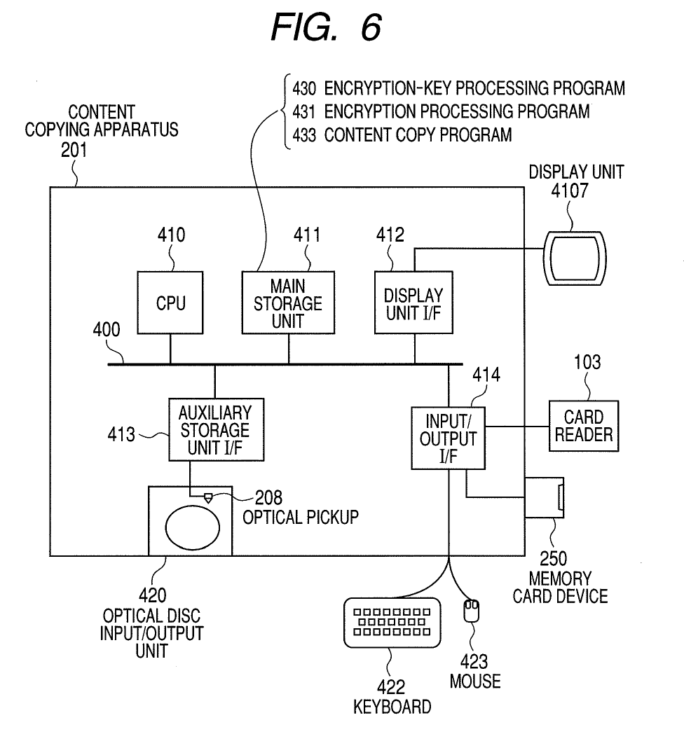

FIG. 6 is a diagram illustrating a hardware configuration of a content copying apparatus according to the second embodiment of the present invention.

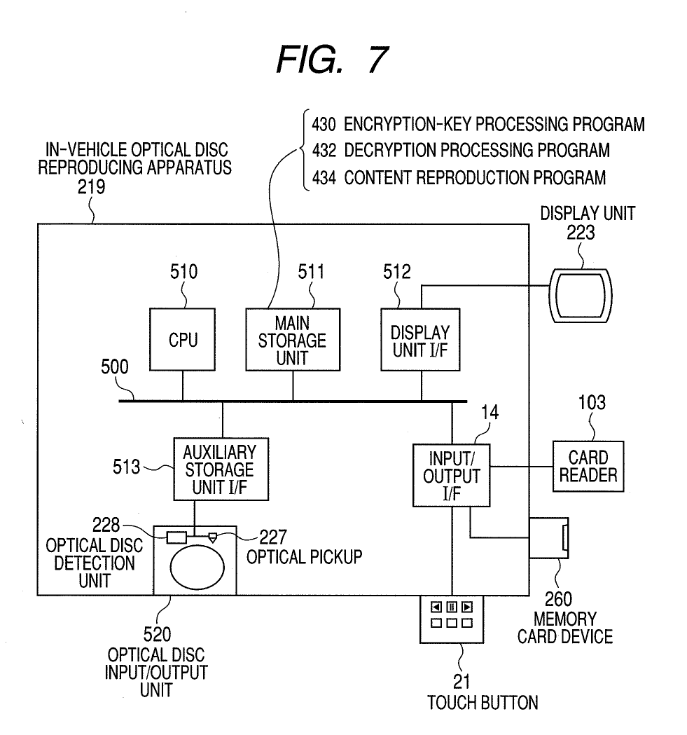

FIG. 7 is a diagram illustrating a hardware configuration of an in-vehicle optical disc apparatus according to the second embodiment of the present invention.

The first embodiment describes an example in which the in-vehicle optical disc reproducing apparatus encrypts and decrypts content so that the content is reproduced. According to this embodiment, an apparatus which is separated from an in-vehicle optical disc reproducing apparatus encrypts content; and the encrypted content is transferred to the in-vehicle optical disc reproducing apparatus so that the in-vehicle optical disc reproducing apparatus decrypts the encrypted content to reproduce the decrypted content.

As shown in FIG. 5, the in-vehicle optical disc reproducing system according to this embodiment includes a content copying apparatus 201, and an in-vehicle optical disc reproducing apparatus 219.

The content copying apparatus 201 according to this embodiment is so devised that the control unit 205 reads data from the optical disc 207 into a memory card 206 so that the data can be kept stored therein.

The control unit 205 of the content copying apparatus 201 performs arithmetic processing of data in a memory area 204 as shown in the figure.

In addition, the content copying apparatus 201 includes a card reader 202 for reading information from an IC card or a magnetic card. Accordingly, information can be inputted from the IC card or the magnetic card into the content copying apparatus 201.

The content copying apparatus 201 further includes a memory card device 250 for reading/writing data from/to the memory card. The memory card is a kind of a portable storage medium. The memory card is a card type storage unit that adopts a flash memory as a storage medium. Memory cards are very small in size. What is more, memory cards achieve widespread use as recording media of mobile devices because they consume little electric power when reading/writing data.

The control unit 205 of the content copying apparatus 201 reads disc specific information 214 from the optical disc 207, and reads vehicle specific information from the card reader 202. The control unit 205 then creates an encryption key 240a from the disc specific information 214 and the vehicle specific information. Next, the control unit 205 encrypts original content A of the optical disc 207 to generate content B, and then stores the content B in the memory card 206 through the memory card device 250.

The in-vehicle optical disc reproducing apparatus 219 according to this embodiment has a function of decrypting the content B so as to reproduce the content A generated by the decryption.

A user inserts the IC card, which has been used at the time of the encryption by the content copying apparatus 201, into the card reader 220 of the in-vehicle optical disc apparatus 219 to cause the card reader 220 to read information from the IC card. An arrow in FIG. 5 indicates that an identical IC card 270 is moved from the content copying apparatus 201 to the in-vehicle optical disc reproducing apparatus 219.

In addition, the memory card 206 storing the encrypted content B is inserted into the memory card device 250 of the in-vehicle optical disc apparatus 219 to cause the memory card device 250 to read the content B. Another arrow in FIG. 5 indicates that the identical memory card 206 is moved from the content copying apparatus 201 to the in-vehicle optical disc reproducing apparatus 219.

The user is required to insert also an original optical disc storing the content A into the in-vehicle optical disc apparatus 219.

Next, the control unit 224 of the in-vehicle optical disc reproducing apparatus 219 reads the disc specific information 214 from the optical disc 207, and reads vehicle specific information from the card reader 220. The control unit 224 then creates an encryption key 240b from the disc specific information 214 and the vehicle specific information.

After that, the control unit 224 decrypts the content B read from the memory card 206 by use of the encryption key 240b to generate the content A that is a plain text. The user reproduces the generated content A, which is displayed on the display unit 223.

When the content A is reproduced, a check is made as to whether or not the original optical disc is inserted into the in-vehicle optical disc reproducing apparatus 219. If it is judged that the original optical disc is not inserted into the in-vehicle optical disc reproducing apparatus 219, the reproduction is stopped.

Whether or not the original optical disc 207 is inserted into the in-vehicle optical disc reproducing apparatus 219 can be checked by judging whether or not the disc specific information 214 which has been read first to generate the encryption key coincides with disc specific information of a current optical disc.

Even if the optical disc 207 containing content is a Blu-ray Disc, an optical disc drive of the in-vehicle optical disc reproducing apparatus 219 has only to have a function of reading disc specific information 214. FIG. 6 is a diagram illustrating in more detail a hardware configuration of the content copying apparatus 201. Here, a low-priced DVD-ROM apparatus may also be used as the content copying apparatus 201.

The content copying apparatus 201 has architecture similar to that of the in-vehicle optical disc reproducing apparatus shown in FIG. 2. The content copying apparatus 201 is configured such that a CPU 410, a main storage unit 411, a display unit I/F 412, an auxiliary storage unit I/F 413, and an input/output I/F 414 are connected to one another through a bus 400. This configuration can be implemented by an ordinary PC (personal computer). It is to be noted that although a hard disk drive is not illustrated, ordinary PCs are generally equipped with a hard disk drive.

Each function of the content copying apparatus 201 is similar to that of the in-vehicle optical disc reproducing apparatus 101 shown in FIG. 2.

Programs executed in the content copying apparatus 201 according to this embodiment include an encryption-key processing program 430, an encryption processing program 431, and a content copy program 433.

The encryption-key processing program 430 is a program having the same function as that of the encryption-key processing program 30 of the in-vehicle optical disc reproducing apparatus 101 shown in FIG. 2.

The encryption processing program 431 is a program having the same function as that of the encryption processing program 31 of the in-vehicle optical disc reproducing apparatus 101 shown in FIG. 2.

The content copy program 431 is a program having the same function as that of the content copy program 33 of the in-vehicle optical disc reproducing apparatus 101 shown in FIG. 2.

However, a point of difference of the above programs from those of the in-vehicle optical disc reproducing apparatus 101 according to the first embodiment is that the encrypted content B is stored in the memory card 206.

The memory card device 250 into which the memory card 206 is inserted is connected to the input/output I/F 414. The memory card device 250 reads/writes data from/to the memory card 206.

Moreover, a keyboard 422 and a mouse 423 are also connected to the input/output I/F 414. The keyboard 422 and the mouse 423 are used by the user to input a command into the content copying apparatus 201.

FIG. 7 illustrates in more detail the hardware configuration of the in-vehicle optical disc reproducing apparatus 219.

The in-vehicle optical disc reproducing apparatus 219 has architecture similar to that of the in-vehicle optical disc reproducing apparatus shown in FIG. 2. The in-vehicle optical disc reproducing apparatus 219 is configured such that a CPU 510, a main storage unit 511, a display unit I/F 512, an auxiliary storage unit I/F 513, and an input/output I/F 514 are connected to one another through a bus 500.

Each function of the in-vehicle optical disc reproducing apparatus 219 is similar to that of the in-vehicle optical disc reproducing apparatus 101 shown in FIG. 2.

Programs executed in the in-vehicle optical disc reproducing apparatus 219 according to this embodiment include the encryption-key processing program 430, a decryption processing program 432, and a content reproduction program 434.

The decryption processing program 432 is a program having the same function as that of the decryption processing program 32 of the in-vehicle optical disc reproducing apparatus 101 shown in FIG. 2.

The content reproduction program 434 is a program having the same function as that of the content reproduction program 34 of the in-vehicle optical disc reproducing apparatus 101 shown in FIG. 2.

However, a point of difference of the above programs from those of the in-vehicle optical disc reproducing apparatus 101 according to the first embodiment is that the encrypted content B is read from the memory card 206.

The memory card device 260 into which the memory card 206 is inserted is connected to the input/output I/F 514. The memory card device 260 reads/writes data from/to the memory card 206.

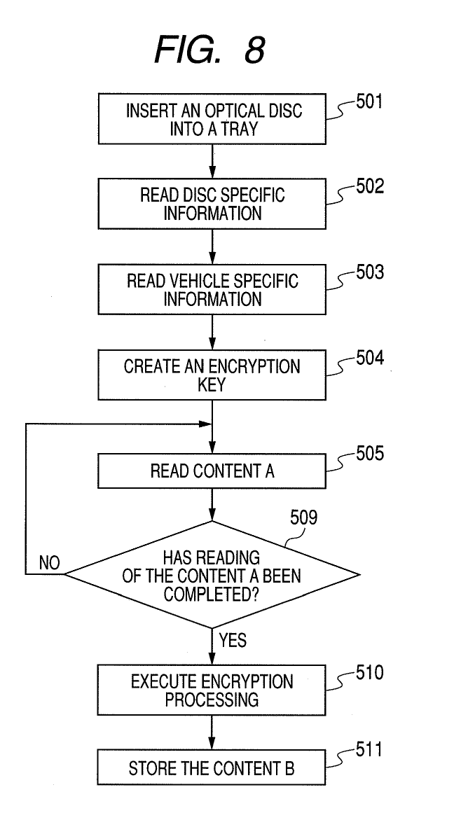

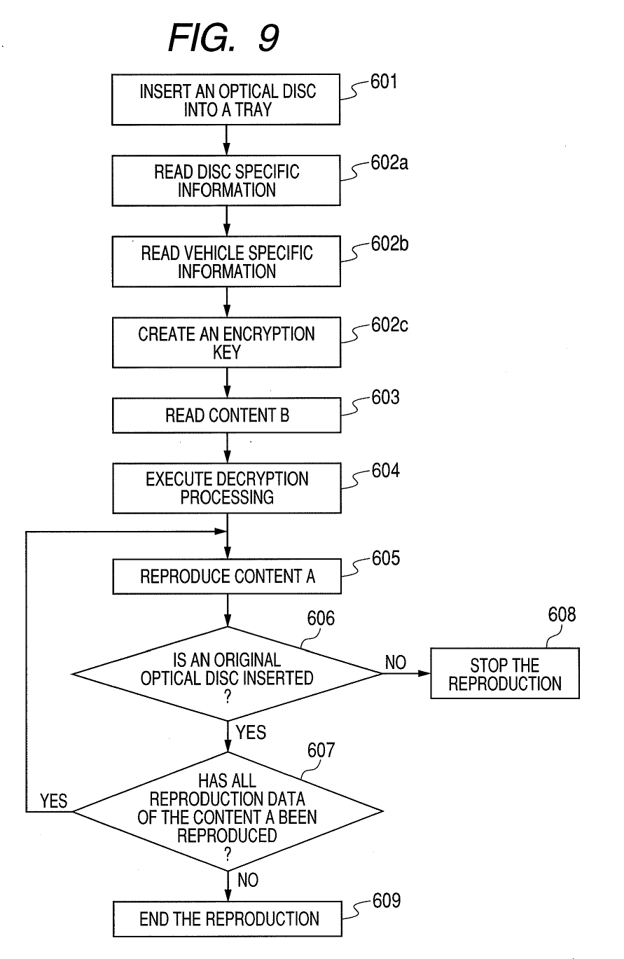

Next, processing of the in-vehicle optical disc reproducing apparatus 101 according to this embodiment will be described with reference to FIGS. 8 and 9 as well as FIGS. 5 to 7 described above.

FIG. 8 is a flowchart illustrating processing of copying content by the content copying apparatus 201 according to the second embodiment of the present invention.

FIG. 9 is a flowchart illustrating processing of reproducing content by the in-vehicle optical disc reproducing apparatus 219 according to the second embodiment of the present invention.

The processing of copying content by the content copying apparatus 201 shown in FIG. 8 is substantially the same as the processing of copying content by the in-vehicle optical disc reproducing apparatus 101 according to the first embodiment shown in FIG. 3. However, the processing shown in FIG. 8 does not include the steps 506, 507 and 508 shown in FIG. 3. This means that when the content A is read, vibrations are not checked. This is a point of difference between them.

The processing of reproducing content by the in-vehicle optical disc reproducing apparatus 219 shown in FIG. 9 is substantially the same as the processing of reproducing content by the in-vehicle optical disc reproducing apparatus 101 according to the first embodiment shown in FIG. 4. However, the step 602 shown in FIG. 4 is replaced with a step of reading disc specific information (step 602a), a step of reading vehicle specific information (step 602b), and a step of creating an encryption key (step 602c). Only this point differs between them.

### Third Embodiment

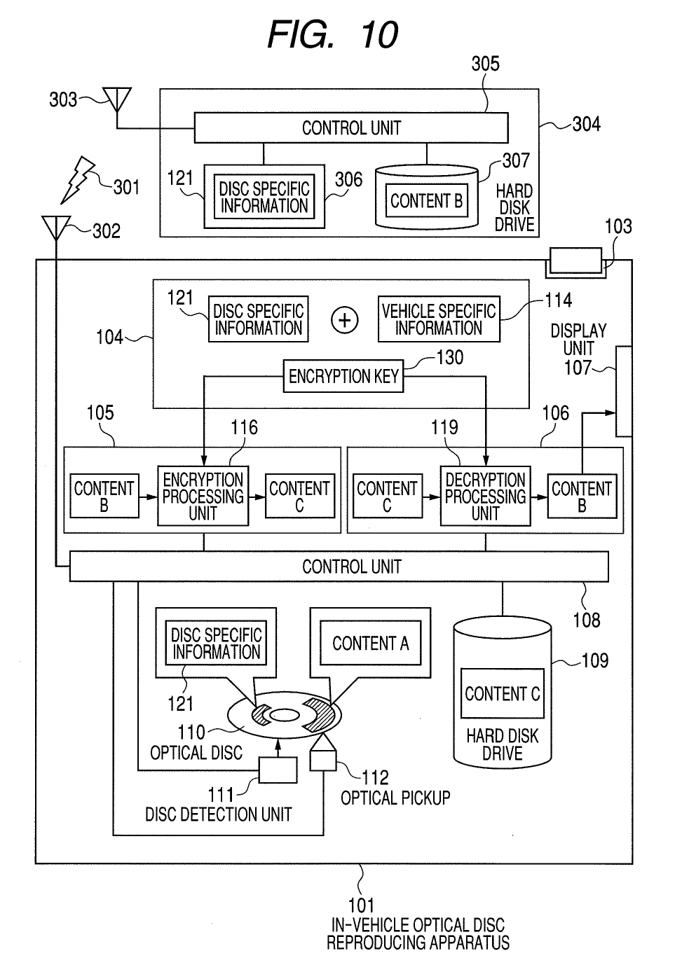

A third embodiment of the present invention will be described below with reference to FIG. 10 to FIG. 12.

FIG. 10 is a diagram illustrating a configuration of an in-vehicle optical disc reproducing system according to the third embodiment of the present invention.

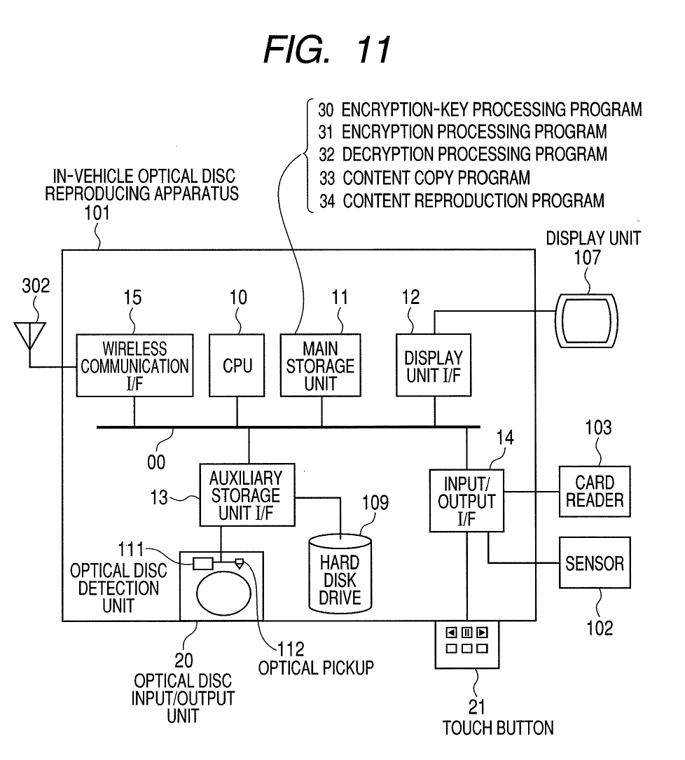

FIG. 11 is a diagram illustrating a hardware configuration of the in-vehicle optical disc reproducing apparatus according to the third embodiment of the present invention.

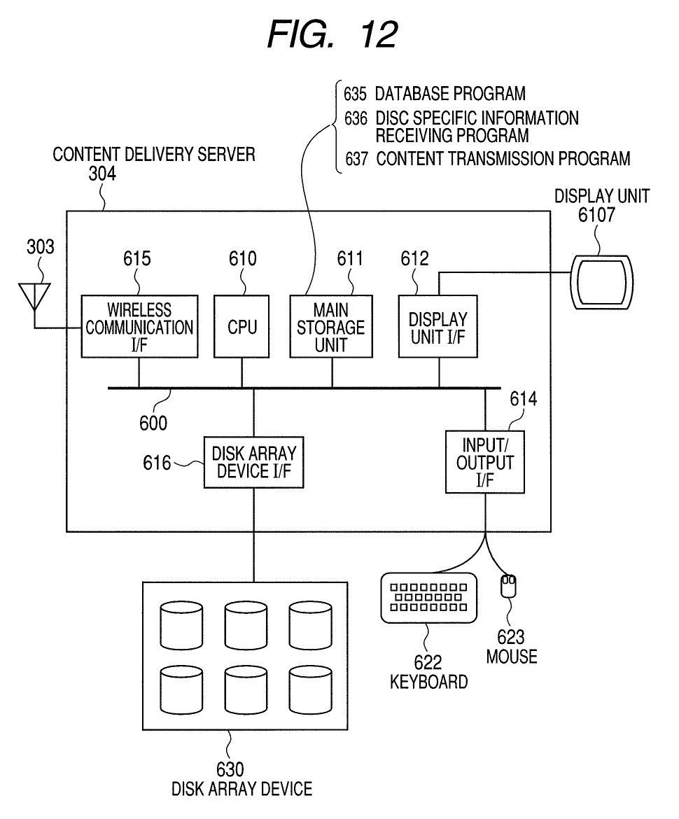

FIG. 12 is a diagram illustrating a hardware configuration of a content delivery server according to the third embodiment of the present invention.

The first embodiment describes an example in which the in-vehicle optical disc reproducing apparatus encrypts and decrypts content so that the content is reproduced. The content to be encrypted is content stored in an optical disc.

According to this embodiment, content to be encrypted is inputted from a content delivery server located outside.

The in-vehicle optical disc reproducing system according to this embodiment includes the in-vehicle optical disc reproducing apparatus 101 and the content delivery server 304.

The in-vehicle optical disc reproducing apparatus 101 according to this embodiment has substantially the same structure as that of the in-vehicle optical disc reproducing apparatus 101 according to the first embodiment. A point of difference between them is that content can be inputted from the outside through an antenna 302 by wireless communications 301.

As is the case with the first embodiment, disc specific information and the content A are stored in the optical disc 110.

The content delivery server 304 is a server having a database of content to be delivered to the in-vehicle optical disc reproducing apparatus 101 by the wireless communications 301. Here, processing performed in a situation in which the content B is delivered as content supplementary to the content A stored in the optical disc 110 will be described.

In order to deliver the content B by the wireless communications 301 to supplement the content A, for example, Managed Copy, which is one of functions of AACS (Advanced Access Content System) included in copyright protection technologies for next-generation optical discs, is extended for the use of in-vehicle apparatuses.

According to this embodiment, the disc specific information 121 of the optical disc 110 is uploaded to the content delivery server 304 so that the disc specific information 121 is kept stored in the memory area 306 of the content delivery server 304.

After that, downloading of the content B which is delivered as content supplementary to the content A is permitted on the basis of the uploaded disc specific information 121.

In this case, as an additional function, it may also be so devised that when downloading of the content B is permitted, not only the above-described disc specific information 121 of the optical disc 110, but also the vehicle specific information inputted from the IC card is requested. The vehicle specific information is information specific to a vehicle such as vehicle information used in an ETC system, and a credit card number used for ETC.

Next, the content B stored in the content delivery server 304 is downloaded to the in-vehicle optical disc reproducing apparatus 101 by the wireless communications 301.

According to this embodiment, the control unit 108 generates the encryption key 130 from the disc specific information 121 and the vehicle specific information 114, and then encrypts the delivered content B.

When the content B is reproduced, content C stored in the hard disk drive 109 is decrypted by use of the encryption key to generate the content B, which is a plain text, so that the content B is reproduced.

In this case, a check is made as to whether or not the original optical disc 110 is inserted into the in-vehicle optical disc reproducing apparatus 101. Only when the original optical disc 110 is inserted, the decrypted content is reproduced. This point is similar to the first embodiment.

Here, information as to whether or not the original optical disc 110 is inserted into the in-vehicle optical disc reproducing apparatus 101 is stored in the memory area 104. The above check is made based on whether or not the disc specific information 121 used for the encryption coincides with the disc specific information of the currently inserted optical disc.

In this embodiment, how to reproduce the content A stored on the original optical disc 110 is not particularly specified. However, the technique based on the method described in the first embodiment may also be used. To be more specific, encrypted content which is copied to the hard disk drive 109 is decrypted before the content is reproduced. Alternatively, the content A may also be merely reproduced just as it is. FIG. 11 illustrates in more detail the hardware configuration of the in-vehicle optical disc reproducing apparatus 101.

The in-vehicle optical disc reproducing apparatus 101 according to this embodiment is configured such that not only the CPU 10, the main storage unit 11, the display unit I/F 12, the auxiliary storage unit I/F 13, and the input/output I/F 14 according to the first embodiment but also a wireless communication I/F 15 are connected to one another through the bus 00. In addition, in-vehicle optical disc reproducing apparatus 101 according to this embodiment is provided with an antenna through which data can be transmitted/received based on specified communications standards.

FIG. 12 illustrates in more detail the hardware configuration of the content delivery server 304.

The content delivery server 304 according to this embodiment is configured such that a CPU 610, a main storage unit 611, a display unit I/F 612, an input/output I/F 614, a wireless communication I/F 615, and a disk array device I/F 616 are connected to one another through a bus 600.

A disk array device 630 is a mass storage device for storing content. The disk array device 630 is connected to the disk array device I/F 616.

Content stored in the disk array device I/F 616 is extracted. The extracted content is passed through the wireless communication I/F 615, and is then transmitted from the antenna 303 to the in-vehicle optical disc reproducing apparatus 101.

Programs to be executed in this embodiment include a database program 635, a disc specific information receiving program 636, and a content transmission program 637. These programs are kept stored in the main storage unit 611.

The database program 635 is a program for managing and accessing content as a database. The database program 635 is a program for, on the basis of the received disc specific information 121, searching for the content B to be downloaded.

The disc specific information receiving program 636 is a program for receiving the disc specific information 121.

The content transmission program 637 is a program for transmitting content to the in-vehicle optical disc reproducing apparatus 101 by wireless communications.

### Fourth Embodiment

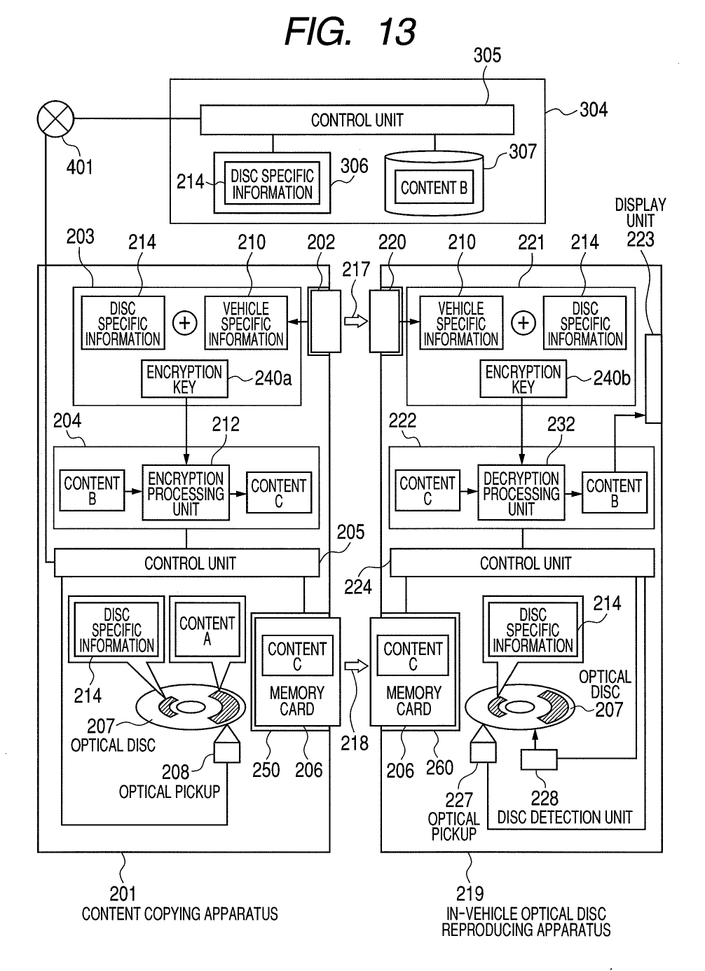

A fourth embodiment of the present invention will be described below with reference to FIG. 13 to FIG. 15.

FIG. 13 is a diagram illustrating a configuration of an in-vehicle optical disc reproducing system according to the fourth embodiment of the present invention.

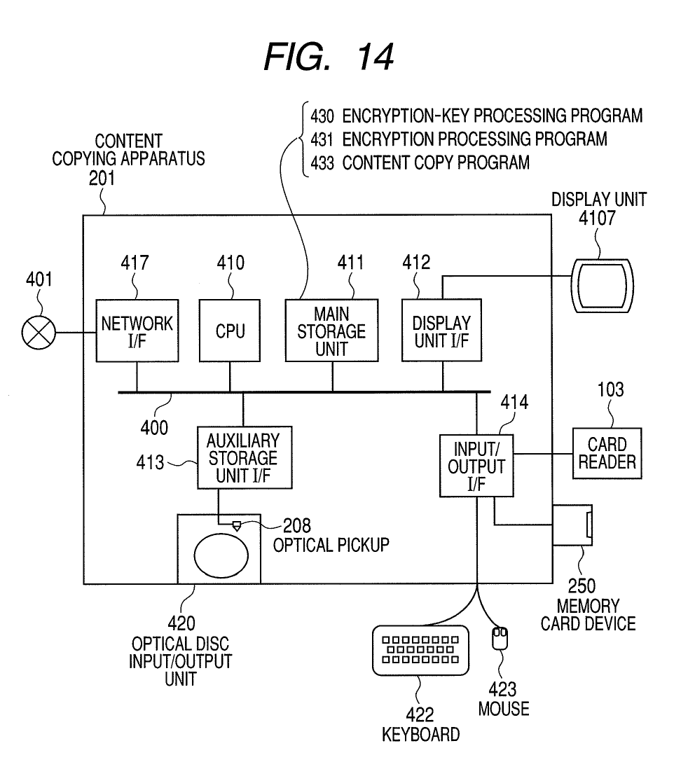

FIG. 14 is a diagram illustrating a hardware configuration of a content copying apparatus according to the fourth embodiment of the present invention.

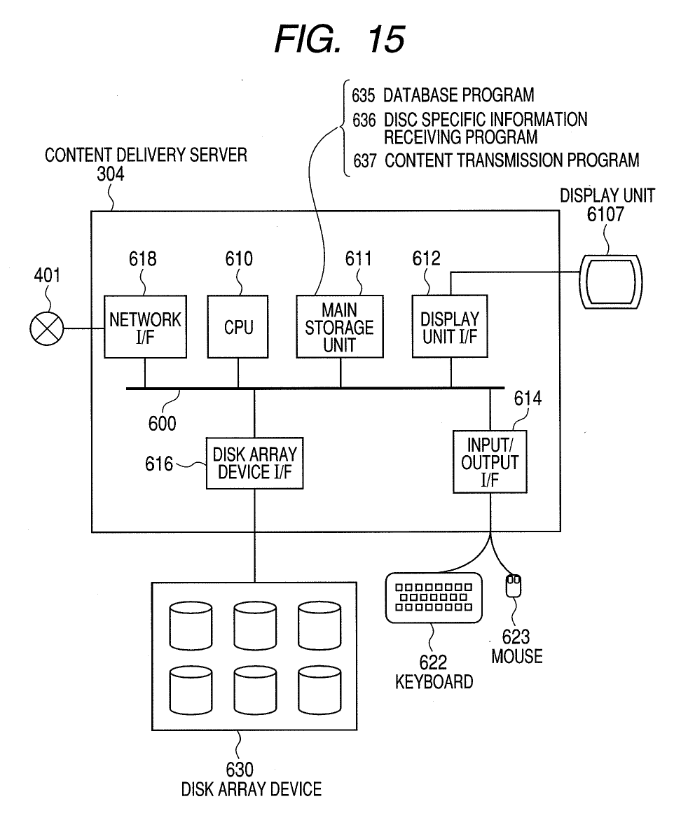

FIG. 15 is a diagram illustrating a hardware configuration of a content delivery server according to the fourth embodiment of the present invention.

A system configuration according to this embodiment is a combination of the system configuration according to the second embodiment and the system configuration according to the third embodiment. According to the second embodiment, the content B is downloaded from the content delivery server 304 to the in-vehicle optical disc reproducing apparatus 101 by the wireless communications 301. In contrast, in this embodiment, the content B is downloaded from the content delivery server 304 to the content copying apparatus 201 through a wired network 401.

Here, processing of writing content to the memory card 206 from the content copying apparatus 201, and processing of decrypting content encrypted by the in-vehicle optical disc reproducing apparatus 219 so that the decrypted content is reproduced, are completely the same as that in the second embodiment.

As shown in FIG. 13, the in-vehicle optical disc reproducing system according to this embodiment includes the content delivery server 304, the content copying apparatus 201, and the in-vehicle optical disc reproducing apparatus 219.

The content delivery server 304 and the content copying apparatus 201 according to this embodiment are connected to the wired network 401 so that data can be transmitted/received between the content delivery server 304 and the content copying apparatus 201.

Points of difference between the third and fourth embodiments are that the third embodiment is based on wireless communications, whereas the fourth embodiment is based on wired communications, and that in the fourth embodiment, content is downloaded from the content delivery server 304 to the content copying apparatus 201.

As is the case with the first embodiment, disc specific information and the content A are stored in the optical disc 110.

Again, as is the case with the third embodiment, what will be described here is processing performed in a situation in which the content B is delivered as content supplementary to the content A stored on the optical disc 110.

According to this embodiment, the disc specific information 121 of the optical disc 110 is uploaded to the content delivery server 304 so as to determine the content B to be delivered as content supplementary to the content A. In addition, the disc specific information 214 of the optical disc 207, which has been uploaded to the content delivery server 304, is kept stored in the memory area 306.

Next, the content B stored in the content delivery server 304 is downloaded to the content copying apparatus 201 through the wired network 401.

Also in this embodiment, the control unit 204 generates the encryption key 240a from the disc specific information 121 and the vehicle specific information 114, and then encrypts the delivered content B as content C.

The encrypted content C is then written to the memory card 206.

A step of inserting, by a user, the memory card 206 storing the encrypted content C into the memory card device 225 of the in-vehicle optical disc apparatus 219, and a step of decrypting the content C by use of the encryption key 240b to reproduce the content B that is a plain text, are completely the same as those in the second embodiment. In addition, if the original optical disc 204 is not inserted into the in-vehicle optical disc apparatus 219 at this point of time, the reproduction of the content B is stopped. This point is also completely the same as that in the second embodiment.

FIG. 14 illustrates in more detail a hardware configuration of the content copying apparatus 201.

The content copying apparatus 201 has architecture similar to that of the in-vehicle optical disc reproducing apparatus shown in FIG. 2. The content copying apparatus 201 is configured such that not only the CPU 410, the main storage unit 411, the display unit I/F 412, the auxiliary storage unit I/F 413, and the input/output I/F 414 but also a network I/F 417 are connected to one another through the bus 400.

The wired network 401 is connected to the network I/F 417 so that data can be transmitted/received to/from an apparatus connected to the outside network.

FIG. 15 illustrates in more detail the hardware configuration of the content delivery server 304.

The content delivery server 304 according to this embodiment is configured substantially in the same manner as the content delivery server 304 according to the third embodiment. However, a point of difference between them is that the content delivery server 304 according to this embodiment has the network I/F 618 instead of the wireless communication I/F 15.

The wired network 401 is connected to the network I/F 618 so that data can be transmitted/received to/from an apparatus connected to the outside network.

Effects of the invention that can be understood from the above embodiments

As understood from the above-described embodiments, the present invention makes it possible to provide an optical disc reproducing apparatus in which, when an optical disc (for example, a DVD, a Blu-ray Disc, or the like) containing content whose copyright is protected is reproduced, only an authorized user is permitted to reproduce the content with the copyright of the content protected.

In particular, the present invention makes it possible to provide an optical disc reproducing apparatus that is capable of stably reproducing content stored on a Blu-ray Disc even if the optical disc reproducing apparatus is placed at a location where shaking and vibrations occur (for example, in a vehicle).

What is claimed is:

1. An optical disc reproducing apparatus for reproducing content stored on an optical disc having disc specific information used to identify the optical disc, said optical disc reproducing apparatus comprising:
means for reading the disc specific information of the optical disc;
means for inputting environmental information about a position at which the optical disc reproducing apparatus is placed, or specific information of the optical disc reproducing apparatus;
means for creating an encryption key from the disc specific information in combination with the environmental information about a position at which the optical disc reproducing apparatus is placed, or in combination with the specific information of the optical disc reproducing apparatus;
means for encrypting first content stored on the optical disc by use of the encryption key to generate second content;
means for storing the second content in an auxiliary storage device;
means for decrypting the second content stored in the auxiliary storage device by use of the encryption key to generate the first content;
means for judging whether or not disc specific information of an inserted optical disc coincides with the disc specific information used when the encryption key has been created; and
means for, if it is judged that the disc specific information of the inserted optical disc coincides with the disc specific information used when the encryption key has been created, reproducing the first content generated by the decryption.

2. An in-vehicle optical disc reproducing apparatus placed in a mobile object for reproducing content stored on an optical disc having disc specific information for identifying the optical disc, said in-vehicle optical disc reproducing apparatus comprising:
means for reading the disc specific information of the optical disc;
means for inputting vehicle specific information of the mobile object;
means for creating an encryption key from the disc specific information and the vehicle specific information;
means for encrypting first content stored on the optical disc by use of the encryption key to generate second content;
means for storing the second content in an auxiliary storage device;
means for decrypting the second content stored in the auxiliary storage device by use of the encryption key to generate the first content;
means for judging whether or not disc specific information of an inserted optical disc coincides with the disc specific information used when the encryption key has been created; and
means for, if it is judged that the disc specific information of the inserted optical disc coincides with the disc specific information used when the encryption key has been created, reproducing the first content generated by the decryption.

3. The in-vehicle optical disc reproducing apparatus according to claim 2, wherein:
said mobile object includes means for detecting vibrations of the mobile object; and
when the means for detecting vibrations detects vibrations of the mobile object, said means for storing the second content in the auxiliary storage device interrupts the processing of storing the second content.

4. An optical disc reproducing system for reproducing, by an optical disc reproducing apparatus, content stored on an optical disc having disc specific information used to identify the optical disc, said optical disc reproducing system further including a content copying apparatus, wherein:
said content copying apparatus includes:
means for reading the disc specific information of the optical disc;
means for inputting environmental information about a position at which the optical disc reproducing apparatus is placed, or specific information of the optical disc reproducing apparatus;
means for creating an encryption key from the disc specific information in combination with the environmental information about a position at which the optical disc reproducing apparatus is placed, or in combination with the specific information of the optical disc reproducing apparatus;
means for encrypting first content stored on the optical disc by use of the encryption key to generate second content; and
means for outputting the second content to a portable storage medium;
said optical disc reproducing apparatus includes:
means for reading the disc specific information of the optical disc;
means for inputting environmental information of the optical disc reproducing apparatus;
means for creating an encryption key from the disc specific information and the environmental information; and
means for inputting the second content from the portable storage medium; and
said optical disc reproducing apparatus further includes:
means for decrypting the second content inputted from the portable storage medium by use of the encryption key to generate the first content;
means for judging whether or not disc specific information of an inserted optical disc coincides with the disc specific information used when the encryption key has been created; and
means for, if it is judged that the disc specific information of the inserted optical disc coincides with the disc specific information used when the encryption key has been created, reproducing the first content generated by the decryption.

5. An in-vehicle optical disc reproducing system for reproducing content associated with an optical disc having disc specific information, said in-vehicle optical disc reproducing system including: an in-vehicle optical disc reproducing apparatus placed in a mobile object; and a content delivery server for delivering content to the in-vehicle optical disc reproducing apparatus, said content delivery server being connected to the in-vehicle optical disc reproducing apparatus by wireless communications, wherein:
said in-vehicle optical disc reproducing apparatus includes:
means for reading the disc specific information of the optical disc;
means for inputting vehicle specific information of the mobile object;
means for creating an encryption key from the disc specific information and the vehicle specific information;
means for transmitting the disc specific information to the content delivery server by the wireless communications;
means for receiving first content from the content delivery server by the wireless communications;
means for encrypting the first content received from the content delivery server by use of the encryption key to generate second content;
means for storing the second content in an auxiliary storage device;
means for decrypting the second content stored in the auxiliary storage device by use of the encryption key to generate the first content;
means for judging whether or not disc specific information of an inserted optical disc coincides with the disc specific information used when the encryption key has been created; and
means for, if it is judged that the disc specific information of the inserted optical disc coincides with the disc specific information used when the encryption key has been created, reproducing the first content generated by the decryption; and
said content delivery server includes means for transmitting, to the in-vehicle optical disc reproducing apparatus, the first content associated with the disc specific information received from the in-vehicle optical disc reproducing apparatus.

6. The in-vehicle optical disc reproducing system according to claim 5, wherein:
said mobile object includes means for detecting vibrations of the mobile object; and
when the means for detecting vibrations detects vibrations of the mobile object, said means for storing the second content in the auxiliary storage device interrupts the processing of storing the second content.

7. The in-vehicle optical disc reproducing system according to claim 5, wherein:
said in-vehicle optical disc reproducing apparatus further includes means for further transmitting the vehicle specific information to the content delivery server; and
said content delivery server includes means for transmitting, to the in-vehicle optical disc reproducing apparatus, the first content associated with the disc specific information and the vehicle specific information that have been received from the in-vehicle optical disc reproducing apparatus.

8. An optical disc reproducing system for reproducing content associated with an optical disc having disc specific information used to identify the optical disc, said optical disc reproducing system including: an optical disc reproducing apparatus; a content delivery server for delivering content to the optical disc reproducing apparatus, said content delivery server being connected to the optical disc reproducing apparatus through a network; and a content copying apparatus, wherein:
said content copying apparatus includes:
means for reading the disc specific information of the optical disc;
means for inputting environmental information about a position at which the optical disc reproducing apparatus is placed, or specific information of the optical disc reproducing apparatus;
means for creating an encryption key from the disc specific information in combination with the environmental information about a position at which the optical disc reproducing apparatus is placed, or in combination with the specific information of the optical disc reproducing apparatus;
means for transmitting the disc specific information to the content delivery server through the network;
means for receiving first content from the content delivery server through the network;
means for encrypting the first content stored on the optical disc by use of the encryption key to generate second content; and
means for outputting the second content to a portable storage medium;
said optical disc reproducing apparatus includes:
means for reading the disc specific information of the optical disc;
means for inputting environmental information about a position at which the optical disc reproducing apparatus is placed, or specific information of the optical disc reproducing apparatus;
means for creating an encryption key from the disc specific information in combination with the environmental information about a position at which the optical disc reproducing apparatus is placed, or in combination with the specific information of the optical disc reproducing apparatus; and
means for inputting the second content from the portable storage medium;
said optical disc reproducing apparatus further includes:
means for decrypting the second content inputted from the portable storage medium by use of the encryption key to generate the first content;
means for judging whether or not disc specific information of an inserted optical disc coincides with the disc specific information used when the encryption key has been created; and
means for, if it is judged that the disc specific information of the inserted optical disc coincides with the disc specific information used when the encryption key has been created, reproducing the first content generated by the decryption; and
said content delivery server includes means for transmitting, to the optical disc reproducing apparatus, the first content associated with the disc specific information received from the optical disc reproducing apparatus.

9. An optical disc reproducing method for reproducing, by an optical disc reproducing apparatus, content stored on an optical disc having disc specific information used to identify the optical disc,
said optical disc reproducing apparatus including: a CPU; a main storage unit; and a control unit for carrying out control by executing a program stored in the main storage unit, said optical disc reproducing method comprising the steps of:
according to an instruction from the control unit, reading the disc specific information of the optical disc;
according to an instruction from the control unit, reading environmental information about a position at which the optical disc reproducing apparatus is placed, or specific information of the optical disc reproducing apparatus;
according to an instruction from the control unit, creating an encryption key from the disc specific information in combination with the environmental information about a position at which the optical disc reproducing apparatus is placed, or in combination with the specific information of the optical disc reproducing apparatus;
according to an instruction from the control unit, encrypting first content stored on the optical disc by use of the encryption key to generate second content;
according to an instruction from the control unit, storing the second content in an auxiliary storage device;
according to an instruction from the control unit, decrypting the second content stored in the auxiliary storage device by use of the encryption key to generate the first content;
according to an instruction from the control unit, judging whether or not an optical disc is inserted, and judging whether or not disc specific information of the inserted optical disc coincides with the disc specific information used when the encryption key has been created; and
according to an instruction from the control unit, if it is judged that the disc specific information of the inserted optical disc coincides with the disc specific information used when the encryption key has been created, reproducing the first content generated by the decryption.

10. An optical disc reproducing method for reproducing, by an in-vehicle optical disc reproducing apparatus placed in a mobile object, content stored on an optical disc having disc specific information used to identify the optical disc,
said in-vehicle optical disc reproducing apparatus including: a CPU; a main storage unit; and a control unit for carrying out control by executing a program stored in the main storage unit,
said optical disc reproducing method comprising the steps of:
according to an instruction from the control unit, reading the disc specific information of the optical disc;
according to an instruction from the control unit, reading vehicle specific information of the mobile object;
according to an instruction from the control unit, creating an encryption key from the disc specific information and the vehicle specific information;
according to an instruction from the control unit, encrypting first content stored on the optical disc by use of the encryption key to generate second content;
according to an instruction from the control unit, storing the second content in an auxiliary storage device;
according to an instruction from the control unit, decrypting the second content stored in the auxiliary storage device by use of the encryption key to generate the first content;
according to an instruction from the control unit, judging whether or not disc specific information of an inserted optical disc coincides with the disc specific information used when the encryption key has been created; and
according to an instruction from the control unit, if it is judged that the disc specific information of the inserted optical disc coincides with the disc specific information used when the encryption key has been created, reproducing the first content generated by the decryption.

11. The optical disc reproducing method according to claim 10, wherein
if the control unit is notified that vibrations have occurred in the mobile object, the control unit stops the step of storing the second content in the auxiliary storage device.

12. An optical disc reproducing method for reproducing, by an optical disc reproducing apparatus, content stored on an optical disc having disc specific information used to identify the optical disc, said optical disc reproducing method using a content copying apparatus,
said content copying apparatus including: a CPU; a main storage unit; and a control unit for carrying out control by executing a program stored in the main storage unit,
said optical disc reproducing apparatus including: a CPU; a main storage unit; and a control unit for carrying out control by executing a program stored in the main storage unit,
said optical disc reproducing method comprising the steps of:
according to an instruction from the control unit of the content copying apparatus, reading the disc specific information of the optical disc;
according to an instruction from the control unit of the content copying apparatus, reading environmental information about a position at which the optical disc reproducing apparatus is placed, or specific information of the optical disc reproducing apparatus;
according to an instruction from the control unit of the content copying apparatus, creating an encryption key from the disc specific information in combination with the environmental information about a position at which the optical disc reproducing apparatus is placed, or in combination with the specific information of the optical disc reproducing apparatus;
according to an instruction from the control unit of the content copying apparatus, encrypting first content stored on the optical disc by use of the encryption key to generate second content;
according to an instruction from the control unit of the content copying apparatus, outputting the second content to a portable storage medium;
according to an instruction from the control unit of the optical disc reproducing apparatus, reading the disc specific information of the optical disc;
according to an instruction from the control unit of the optical disc reproducing apparatus, reading environmental information about a position at which the optical disc reproducing apparatus is placed, or specific information of the optical disc reproducing apparatus;
according to an instruction from the control unit of the optical disc reproducing apparatus, creating an encryption key from the disc specific information in combination with the environmental information about a position at which the optical disc reproducing apparatus is placed, or in combination with the specific information of the optical disc reproducing apparatus;
according to an instruction from the control unit of the optical disc reproducing apparatus, reading the second content from the portable storage medium;
according to an instruction from the control unit of the optical disc reproducing apparatus, decrypting the second content inputted from the portable storage medium by use of the encryption key to generate the first content;
according to an instruction from the control unit of the optical disc reproducing apparatus, judging whether or not disc specific information of an inserted optical disc coincides with the disc specific information used when the encryption key has been created; and
according to an instruction from the control unit of the optical disc reproducing apparatus, if it is judged that the disc specific information of the inserted optical disc coincides with the disc specific information used when the encryption key has been created, reproducing the first content generated by the decryption.
